(19) United States
(12) Patent Application Publication
(10) Pub. No.: US 2014/0092127 A1
(43) Pub. Date: Apr. 3, 2014

(54) MEDIA ANNOTATIONS IN NETWORKED ENVIRONMENT

(71) Applicant: Ezekiel Kruglick, Poway, CA (US)

(72) Inventor: Ezekiel Kruglick, Poway, CA (US)

(73) Assignee: Empire Technology Development LLC, Wilmington, DE (US)

(21) Appl. No.: 13/980,033

(22) PCT Filed: Jul. 11, 2012
(86) PCT No.: PCT/US12/46325

§ 371 Date: Dec. 3, 2013

(51) Int. Cl. G06T 11/60; G06F 21/84

(52) U.S. Cl. CPC G06T 11/60; G06F 21/84
USPC 345/629

(57) ABSTRACT

Technologies are generally described for allowing insertion of annotations on media and display of the annotations along with the media. For example, in some embodiments, the described technologies enable a user to insert annotations on media and enable viewers associated with the annotating user to view the annotations when viewing the media. The annotating user may be enabled to define who can view the annotations and/or when the annotations are to be displayed in reference to the media. A content provider hosting the media and/or a communication network intermediating request and transfer of the media may determine whether a requesting viewer has a relationship with the annotating user. If the viewer and annotating user are associated or the viewer has specifically requested the annotations from the annotating user, the annotated media may be provided to the requesting viewer.

### BACKGROUND

Unless otherwise indicated herein, the materials described in this section are not prior art to the claims in this application and are not admitted to be prior art by inclusion in this section.

In a networked media sharing environment, users may desire to insert comments on media files such as videos, music, presentations, slideshows, and other audio/visual files. The comments may be content specific such that the inserted comment may be relevant to the content of the media at a particular timeframe, and a viewing user may desire for the inserted comment to be displayed at the relevant timeframe when the media is viewed. Additionally, media files may be made publicly available to mass audiences over communication networks such as social networks, enterprise networks, professional networks and other content providers. When the media files are publicly available, any user may be able to insert a comment on the media, and a viewer of the media may be overwhelmed by a large number of comments. Additionally, the viewer of the media may view comments made by users the viewer does not know and which may be of no importance to the viewer. The viewer may desire to only view comments from users who the viewer knows or is associated with, in order to view comments that are significant and meaningful to the viewer.

### SUMMARY

The present disclosure generally describes techniques for displaying annotations on shared media from an annotation source associated with a viewer. According to some examples, the present disclosure describes a method for displaying annotations on shared media. The method may include receiving a request for media, determining an available annotation for the requested media, determining if a requesting viewer is allowed to view the available annotation, if the requesting viewer is allowed to view the available annotation, overlaying the available annotation with the media, and providing the annotated media to the requesting viewer.

According to other examples, the present disclosure also describes a system for displaying annotations on shared media. The system may include a communication network configured to enable users exchange communications and share media, and a media annotation module executed on a server. The media annotation module may be configured to receive a request for media, determine available annotation for the requested media, determine if a requesting viewer is allowed to view the available annotation, if the requesting viewer is allowed to view the available annotation, overlay the available annotation with the media, and provide the annotated media to the requesting viewer.

According to further examples, the present disclosure also describes a system for displaying annotations on shared media. The system may include a data store configured to store media for sharing and a content provider server. The content provider server may be configured to receive a request for media, determine available annotation for the requested media, determine if a requesting viewer is allowed to view the available annotation, if the requesting viewer is allowed to view the available annotation, overlay the available annotation with the media, and provide the annotated media to the requesting viewer.

According to yet other examples, the present disclosure describes a computer readable memory device with instructions stored thereon for displaying annotations on shared media. The instructions may include receiving a request for media, determining an available annotation for the requested media, determining if a requesting viewer is allowed to view the available annotation, if the requesting viewer is allowed to view the available annotation, overlaying the available annotation with the media, and providing the annotated media to the requesting viewer.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIGS. 1A through 1D illustrate example scenarios for providing annotated media in which the media and the annotations are provided by different sources;

FIG. 2 illustrates an example annotation overlaid with a media file;

FIG. 3 illustrates actions in an example scenario for enabling a viewer to view annotations by users associated with the viewer;

FIG. 4 illustrates a general purpose computing device, which may be used to control a system for displaying annotations on shared media from an annotation source associated with a viewer;

FIG. 5 is a flow diagram illustrating an example method that may be performed by a computing device such as the computing device in FIG. 4; and

FIG. 6 illustrates a block diagram of an example computer program product, all arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems, devices, and/or computer program products related to displaying annotations on shared media from an annotation source associated with a viewer.

Briefly stated, technologies are generally described for allowing insertion of annotations on media and display of the annotations along with the media. For example, in some embodiments, the described technologies enable a user to insert annotations on media and enable viewers associated with the annotating user to view the annotations when viewing the media. The annotating user may be enabled to define who can view the annotations and/or when the annotations are to be displayed in reference to the media. A content provider hosting the media and/or a communication network intermediating request and transfer of the media may determine whether a requesting viewer has a relationship with the annotating user. If the viewer and annotating user are associated or the viewer has specifically requested the annotations from the annotating user, the annotated media may be provided to the requesting viewer.

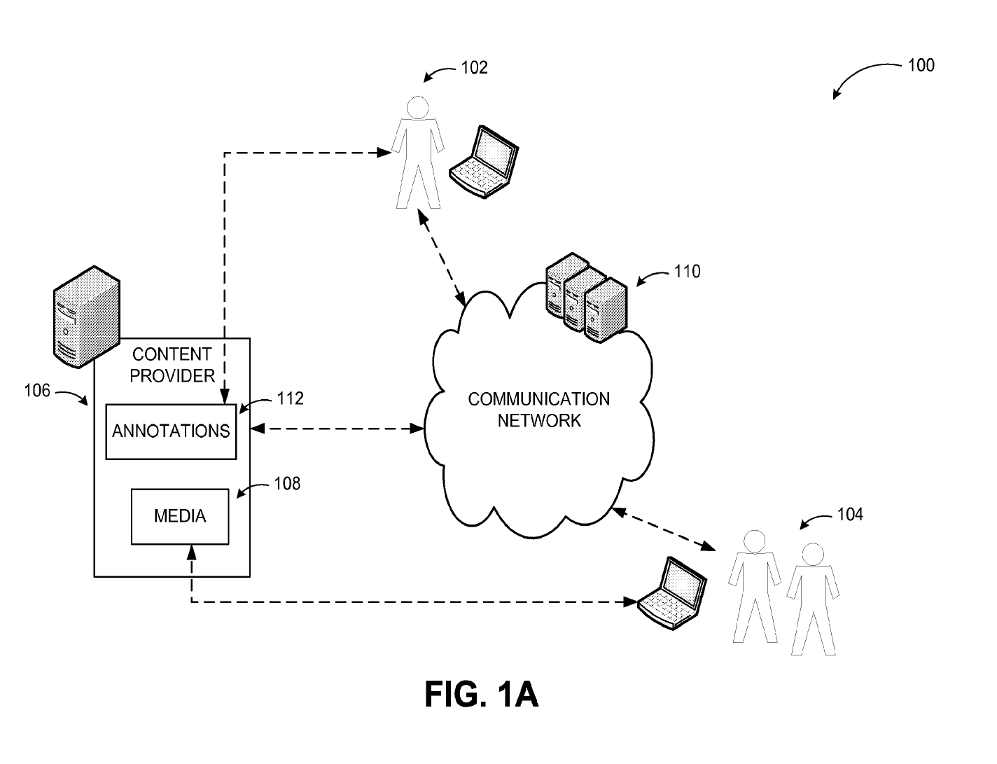

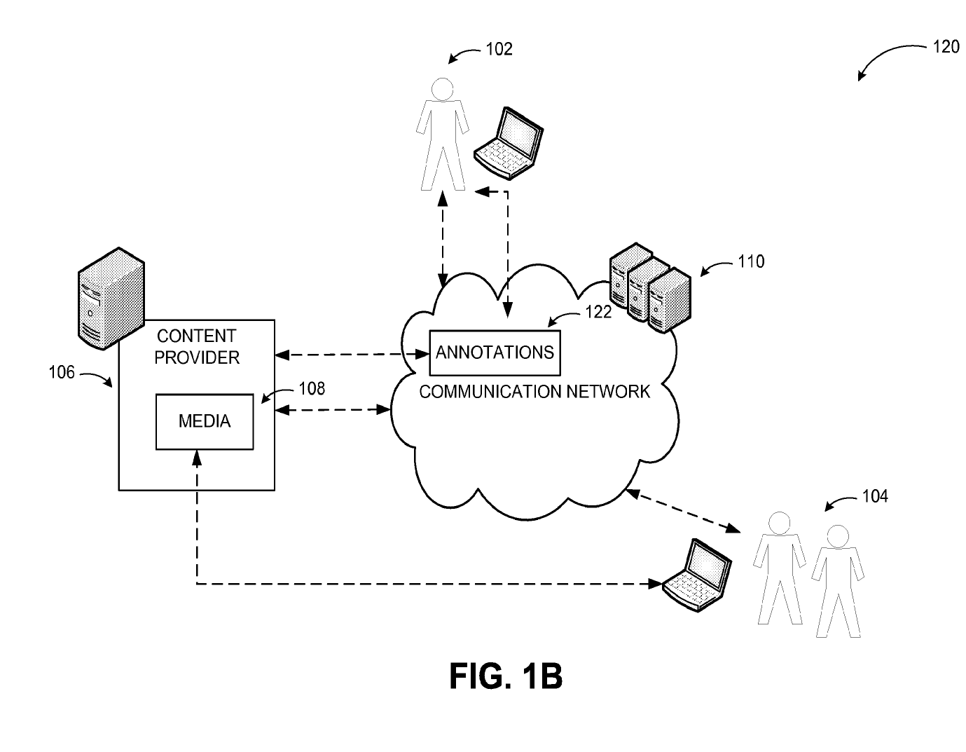

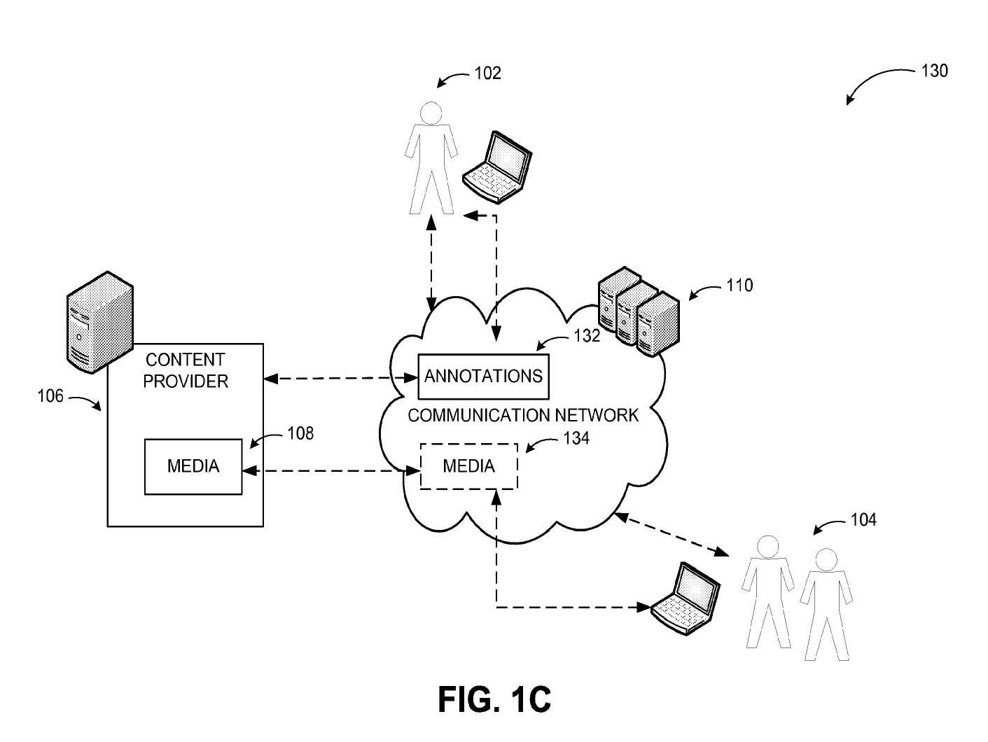

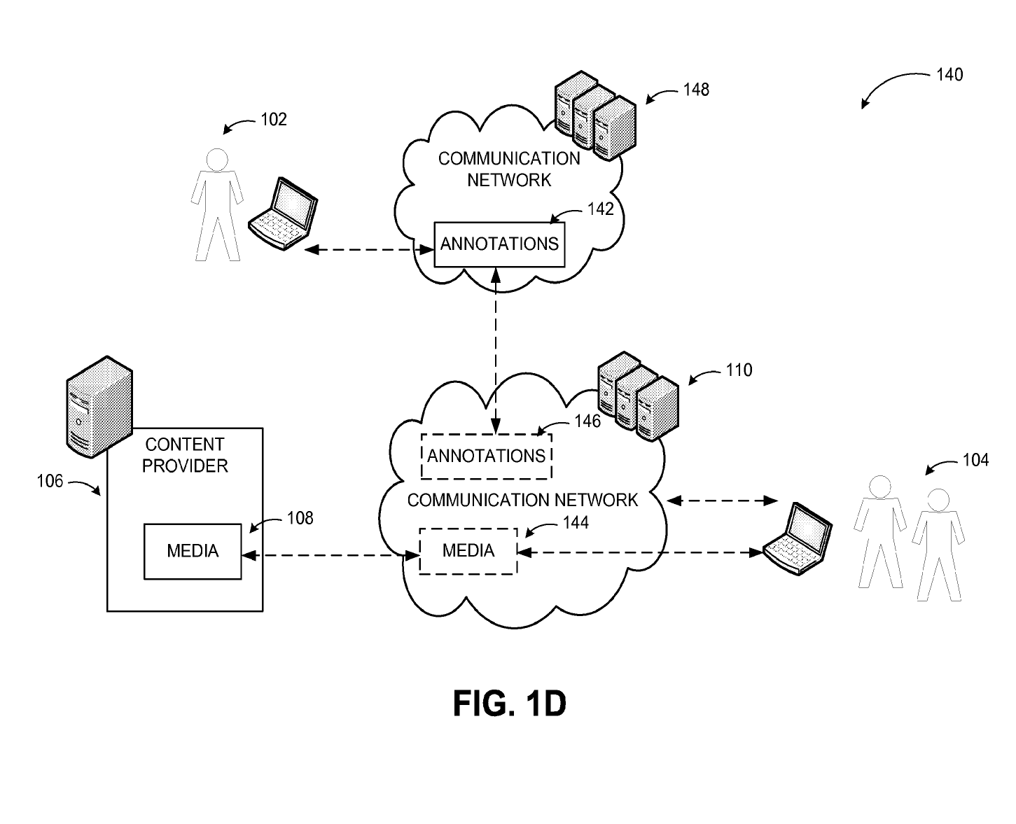

FIG. 1A through 1D illustrate example scenarios for providing annotated media in which the media and the annotations are provided by different sources, arranged in accordance with at least some embodiments described herein. FIG. 1A illustrates a scenario where media and annotations associated with the media may be stored and overlaid at a content provider. As demonstrated in a diagram 100, a content provider 106 may host and provide media 108, which may be viewed directly from the content provider 106. Examples of the media 108 may include audio/visual content such as video files, streaming audio/video, presentations, or audio files. Additionally, the content provider 106 may provide the media 108 to a communication network 110, where it may be viewed by one or more viewers. Example communication networks may include a social network, an enterprise network, and/or a professional network, as well as other platforms for viewing media such as a blog or other information exchange sites.

In an example embodiment, an annotating user 102 may desire to annotate or insert a comment onto the media 108 corresponding to a particular timeframe of the media 108 so that the comment may be displayed at the appropriate timeframe when the media 108 is viewed by a viewer 104. For example, the annotating user 102, may desire to make a comment on a video file that is relevant to the content at the 2:00 minute mark of a video file. Here, the appropriate timeframe is the 2:00 minute mark in the video file. Instead of including the comment in an overall comments section, which may accompany the video file and specifically indicating that the comment is relevant to the content at the 2:00 minute mark, the annotating user 102 may insert the comment directly on the video at the 2:00 mark. When the viewer 104 views the video file, the annotating user's comment may be displayed when the video reaches the 2:00 minute mark, so that the viewer 104 reads the comment as the viewer 104 views the relevant content associated with the comment. The comment may be a textual comment, a graphical comment, a combination of text and graphics, audio, or video.

In a system according to embodiments, the annotating user 102 may wish to control who can view the annotating user's comments on the media 108. For example, the annotating user 102 may annotate the media 108, which may be available publicly to a mass audience by the content provider and/or over one or more communication networks. The annotating user 102 may specify that the comments should not be publicly displayed to all viewers, and the annotating user 102 may wish to control who may view the comments. For example, the annotating user 102 may specify who may view the comments based on the identity of the viewers. The annotating user may wish to limit who may view the comments to viewers who are associated with the annotating user 102, and in another example the annotating user 102 may limit who may view the comments based on a type or category of viewer, such as viewers belonging to a particular industry, age group, or school as some examples. Further, the viewer 104 may also be enabled to specify whose annotations the viewer 104 desires to view, so that the viewer 104 may view annotations from an annotating users the viewer 104 is associated with and/or from annotating users the viewer 104 specifically selects. Additionally, the content provider and/or the communication network providing the media and accompanying annotations may define permissions in order to control who can view the annotating user's comments and annotations on the media.

In another example embodiment, the insertion of annotations and comments on media by one or more annotating users may be limited based on a role-based permission. The annotating user 102 may desire to annotate the media 108, which may be available publicly to a mass audience, and the content provider 106 and/or one or more communication networks may limit who may annotate the media in order to control the annotated media. For example, the content provider and/or the communication network receiving the request to annotate media from the annotating user may determine if the annotating user has permission to annotate the media based on predefined role-based permission settings. The role-based permission settings may define users who may have permission to annotate the media, and the role-based permission settings may be customized by the source of the media, as well as by the content provider, and the communication network providing the media. Similar role-based permissions may also be employed in limiting who can view annotated media by select annotating users in further examples.

The diagram 100 illustrates an example scenario where the content provider 106 may store and provide the media 108, and may also store annotations 112 associated with the media 108. In a system according to some embodiments, the media 108 may be annotated by one or more annotating users. The annotating user 102 may access the media 108 directly via the content provider 106 and may also access the media 108 over the communication network 110. The annotating user 102 may annotate the media 108 by inserting one or more comments at selected timeframes of the media 108. Examples of the annotations 112 may be textual, audio, and/or video comments, which may be inserted within the media 108 and displayed concurrently with the media 108 as it is viewed. The annotations 112 accompanying the media 108 may be stored separately in an annotations data store associated with the content provider 106 or stored along with the media (e.g., as metadata).

In an example embodiment, the viewer 104 may request to view the media 108 from the content provider 106. The requested media 108 may be provided to the viewer 104 directly from the content provider 106, which may be a video hosting website for example. Alternatively, the content provider 106 may receive a request for media via the communication network 110, and the requested media 108 may be provided to the viewer 104 over the communication network 110. For example, the viewer 104 may request to view the media 108 on a social network, and the social network may retrieve the media 108 from the content provider 106 for providing the media 108 to the viewer 104. Upon receiving the request to view the media 108 from the viewer 104, the content provider 106 may determine if there are any annotations associated with the requested media 108. If the content provider 106 identifies one or more annotations associated with the requested media 108, the content provider 106 may determine if the annotations 112 should be displayed with the requested media 108 based on determining if the requesting viewer 104 is permitted to view the annotations 112.

In a system according to embodiments, the content provider 106 may determine if the requesting viewer 104 is permitted to view the annotations 112 based on determining if the requesting viewer 104 is associated with or has a relationship with the annotating user 102. The relationship of the requesting viewer with the annotating user 102 may include a family relationship, a friendship, and a professional relationship. For example, if media is requested over a social network, the content provider may determine if the requesting viewer 104 is associated with the annotating user 102 based on established relationships identified from the social network. From the established relationships on the social network, it may be determined if the requesting viewer 104 and the annotating user 102 are linked on the social network as friends, acquaintances, mutual followers, co-workers, family members, and/or as members of established groups.

Additionally, the content provider 106 may determine if the requesting viewer 104 is permitted to view the annotations 112 based on determining if the requesting viewer 104 has requested to view annotations by the annotating user 102. For example, the requesting viewer 104 may select to view annotations 112 from particular friends, family, and co-workers or categories thereof only. The content provider 106 and/or the communication network may provide a platform for enabling the requesting viewer 104 to specify which annotations 112 the requesting viewer 104 desires to view. Further examples of determining suitable or available annotations for a viewer may include, but are not limited to, the requesting viewer 104 and the annotating user 102 being included in each other's contacts list and/or address book, prior communication exchanges (e.g., email) between the requesting viewer 104 and the annotating user 102, and comparable commonalities. If the annotations are determined to be suitable or permitted for the requesting viewer 104 based on an identified relationship between the requesting viewer 104 and the annotating user 102 or annotations/annotating user selections by the requesting viewer 104, the content provider 106 may overlay the media 108 with the annotations 112, and the content provider 106 may provide the annotated media to the requesting viewer 104. The content provider 106 may provide the annotated media to the requesting viewer 104 directly via the content provider 106, and additionally the content provider 106 may provide the media with the overlaid annotations to the requesting viewer 104 via the communication network 110.

FIG. 1B illustrates an additional scenario where the annotations associated with media may be stored at a communication network and overlaid at the content provider. As demonstrated in a diagram 120, the annotating user 102 may access the media 108 for inserting annotations over the communication network 110. The annotating user 102 may annotate the media 108 by inserting one or more annotations 122, including textual, video, or audio comments at selected timeframes of the media 108. After the annotating user 102 has inserted the one or more annotations 122 on the media 108 over the communication network 110, the annotations 122 accompanying the media 108 may be stored in an annotations data store associated with the communication network 110.

In an example embodiment, the viewer 104 may request to view the media 108 from the content provider 106, and additionally, the content provider 106 may receive a request for the media 108 via the communication network 110. Upon receiving the request to view the media 108 from the viewer 104, the content provider 106 may access the annotations 122 stored with the communication network 110, and may identify if there are any annotations 122 associated with the requested media 108. If the content provider 106 identifies one or more annotations 122 associated with the requested media 108, the content provider 106 may determine if the requesting viewer 104 is allowed to view the annotations 122 for determining whether to display the annotations 122 with the requested media 108.

In an example embodiment, the requesting viewer 104 may be allowed to view the annotations 112 if the requesting viewer 104 is determined to have a relationship with the annotating user 102. Additionally, the requesting viewer 104 may be allowed to view the annotations 112 if the requesting viewer 104 has selected to view annotations by the annotating user 102, and also if the annotating user 102 has selected to enable the requesting viewer 104 to view the annotating user's 102 annotations. If the requesting viewer 104 is determined to be allowed to view the annotations 122, based on an identified relationship between the requesting viewer 104 and the annotating user 102, as well as the annotations selections by the requesting viewer 104, the content provider 106 may retrieve the annotations 122 from the communication network 110. The content provider 106 may overlay the retrieved annotations 122 with the media 108, and the content provider 106 may provide the annotated media to the requesting viewer 104. The content provider 106 may provide the annotated media to the requesting viewer 104 directly via the content provider 106, and additionally the content provider 106 may provide the media 108 with the overlaid annotations to the requesting viewer 104 via the communication network 110.

FIG. 1C illustrates a scenario where the annotations associated with media may be stored at a communication network and overlaid with the media at the communication network. As demonstrated in a diagram 130, the annotating user 102 may access the media 108 for inserting one or more annotations over the communication network 110. The annotating user 102 may annotate the media 108 by inserting one or more annotations 132, including textual, video, or audio comments at selected timeframes of the media 108. After the annotating user 102 has inserted the one or more annotations 132 on the media 108 over the communication network 110, the annotations 132 accompanying the media 108 may be stored in an annotations data store associated with the communication network 110.

In an example embodiment, the viewer 104 may request to view the media 108 over the communication network 110, and the content provider 106 may receive the request for the media 108 via the communication network 110. Upon receiving the request to view the media 108 from the viewer 104, the communication network 110 may receive the media 108 from the content provider 106. The communication network 110 may access the annotations 132 stored with the commination network 110, and may identify if there are any annotations 132 associated with the requested media 108. If the commination network 110 identifies one or more annotations 132 associated with the requested media 108, the communication network 110 may determine if the requesting viewer 104 is linked to the annotations 132 for determining whether to display the annotations 122 with the requested media 108.

In a system according to embodiments, if the communication network 110 determines that the requesting viewer 104 is allowed to view the annotations 132, based on an identified relationship between the requesting viewer 104 and the annotating user 102, and also based on annotations selections by the requesting viewer 104 and/or the annotating user 102, as described above, then the communication network 110 may overlay the available annotation with the media 108 at the communication network 110. The communication network 110 may provide the annotated media to the requesting viewer 104 directly, and additionally the content provider 106 may provide the media 108 with the overlaid annotations to the requesting viewer 104 via the communication network 110.

FIG. 1D illustrates a scenario where the annotations associated with media may be stored at a first communication network and overlaid with the media at a second communication network. As demonstrated in a diagram 140, in another example scenario, the annotating user 102 may access the media 108 provided by the content provider 106 for inserting annotations over a first communication network 148. The annotating user 102 may annotate the media 108 by inserting one or more annotations 142, including textual, video, or audio comments at selected timeframes of the media 108. After the annotating user 102 has inserted the one or more annotations 142 on the media 108 at the first communication network 148, the annotations 142 accompanying the media 108 may be stored in an annotations data store associated with the first communication network 148.

In an example embodiment, the viewer 104 may request to view the media 108 over the second communication network 110, and upon receiving the request to view media 108 from the viewer 104, the second communication network 110 may retrieve the requested media 108 from the content provider 106. The second communication network 110 may also access the annotations 142 stored with the first commination network 148 for identifying if there are any annotations 142 associated with the requested media 108. If the second communication network 110 identifies one or more annotations 142 associated with the requested media 108, the second communication network 110 may retrieve the annotations 142 from the first communication network 148. The second communication network 110 may determine if the requesting viewer 104 is allowed to view the retrieved annotations 146 for determining whether to display the annotations 122 with the requested media 108.

As previously described, the requesting viewer 104 may be allowed to view the retrieved annotations 146 if a relationship between the annotating user 102 and the requesting viewer 104 is identified. The relationship may be determined based on a profile and/or persona associated with the annotating user 102 and the requesting viewer 104 on one or more communication networks. Additionally, the requesting viewer 104 may be provided the retrieved annotations 146 to view if the requesting viewer 104 has specifically requested to view annotations by the annotating user 102, and also if the annotating user 102 has specified that the requesting viewer 104 can view the annotating user's annotations and comments. Requests can be made by relation, category, group, individual, or the like. If the second communication network 110 determines that the requesting viewer 104 is allowed to view the retrieved annotations 146, the second communication network may overlay the retrieved annotations 146 with the media 108 retrieved from the content provider 106 at the second communication network 110.

In one example embodiment annotations may be overlaid employing Hypertext Markup Language (HTML) and/or transparent overlays. For example, a code may play a content provider video in an HTML window that allows the social network site to overlay local content. HTML DIVs may be drawn over the content provider player on a local web page. In one implementation, WMODE=“transparent” may be used for embedding in the parameter list so that a DIV can be placed “over” the media. An example script may look like:
<script type=“text/javascript”>
var params={allowScriptAccess: “always”};
var atts={id: “mycpplayer”, wmode: “transparent”};
swfobject.embedSWF(“https://www.contentprovider.com/watch?v=oHg5 SJYRHA0&enablejsapi=1&playerapiid=cpplayer”, “cpapiplayer”, “425”, “356”, “8”, null, null, params, atts);
   </script>
      The example script allows a social network or organization site to draw annotations over the content provider video using CSS/DHTML simply by directing it to the DIV the script creates.

Another way to accomplish media annotation similar to the script discussed above using Flash may be to use a content provider action script API. With action script API, a site may load the videos into Flash using the API and then have a local Flash application create the annotations on a layer above the video.

Some conventional approaches to annotation such as services for overlaying annotations on videos typically require the annotations in advance. To employ such an implementation for the approaches discussed herein, the annotations store may retrieve all relevant annotations that may be used and dynamically compose a call from the communication network using only the annotations the individual user should see based on credentials, for example. In a social network environment, social graph information known to the social network site may be used to identify the relevant annotations.

In allowing access to annotations based on a relationship of the annotating user and a viewer, information associated with the viewer and/or the annotating user within the communication network may be employed. For example when a social network controls the annotation filtering, a social graph may be processed to extract social distance and nature of connection between the annotating user and the viewer. In some examples, the annotating user may specify who can see the annotations based on groups or categories, such as “all professional connections” or “all first and second level connections except professional connections.”

In the scenarios, where the content provider performs the annotation, information associated with the viewer and/or the annotating user such as social information may be requested and received from the communication network (e.g., the social network). Increasingly, communication networks collect or infer relationships (“connectedness”) of their subscribers. Such information may be provided to annotating content providers upon request. The relationship information may also include users' preferences, permissions, and so on, which may be used by the content provider to determine authorized viewers for the annotations. The content provider may be able to identify a user to a communication network based on the user's login such as OAuth.

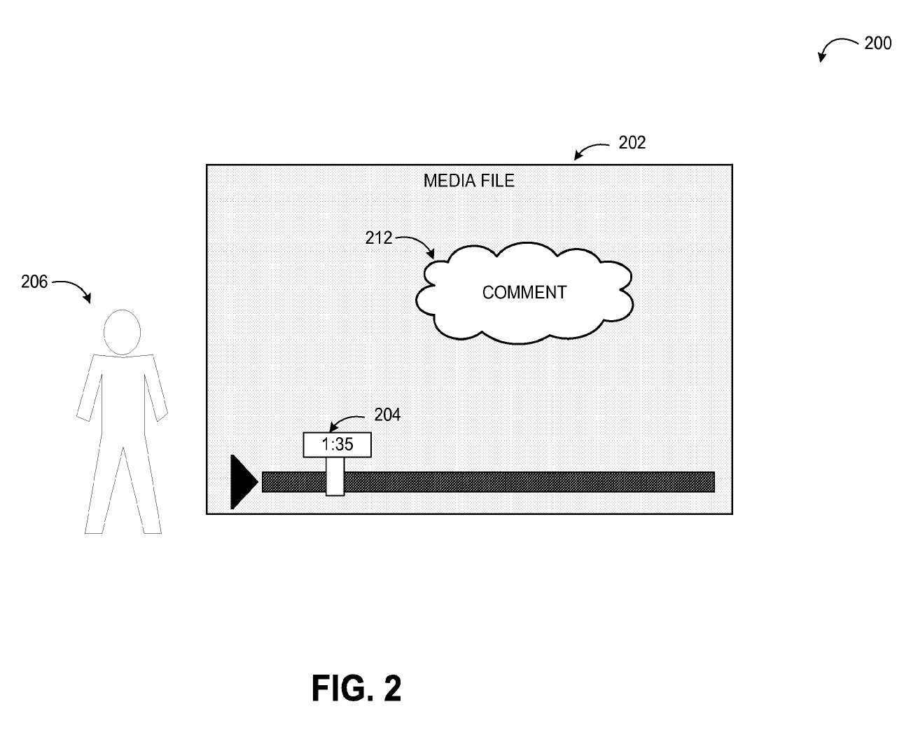

FIG. 2 illustrates an example annotation overlaid with a media file, arranged in accordance with at least some embodiments described herein. In an example embodiment, as demonstrated in a diagram 200, an annotating user 206 may desire to annotate or insert a comment 212 onto a media file 202, such as a video file. The annotating user's comment may be relevant to content at a particular timeframe of the media file 202, and the annotating user 206 may desire for the comment 212 to be displayed at the relevant timeframe when the media file 202 is viewed by a viewer.

In an example scenario, the annotating user 206 may insert the comment 212 on the media file 202 that is relevant to the content at the 1:35 minute timeframe 204. When the viewer views the media file 202, the comment 212 may be displayed when the media file 202 reaches the 1:35 minute timeframe 204, so that the viewer reads the comment 212 as the relevant content associated with the comment 212 is viewed. The comment 212 may be a pop up window which may be displayed on top of the media file 202 when the media file 202 is viewed, and in another example, the comment 212 may be displayed in a separate window next to the media file 202 when the media file is viewed. The inserted comment 212 may be a textual comment, an audio comment, and a video comment, as some examples. If the inserted comment 212 is an audio and/or comment by the annotating user 206, the comment 212 may include an option for the viewer to select to play the comment 212, and the media file 202 may be paused while the viewer listens to and/or watches the comment 212. After the viewer listens to and/or watches the comment 212, the media file 202 may resume.

In another example embodiment, a preview of the media file 202 may be provided to one or more viewers for indicating that one or more annotations accompany the media file 202. For example the content provider and/or the communication network utilized for requesting and viewing the media file 202 may post a screenshot of the media with the overlaid comment 212 for indicating to the viewer that the media file 202 includes one or more available annotations. For example such a screenshot may automatically appear in a menu or in a social feed. Additionally the screenshot may be configured to indicate the annotating users who have annotated the media file 202, and the date and time when the annotations were made to the media file. The screenshot may also indicate the number of available annotations associated with the media file 202, in order to provide a comprehensive preview to viewers of the available annotations overlaid with the media.

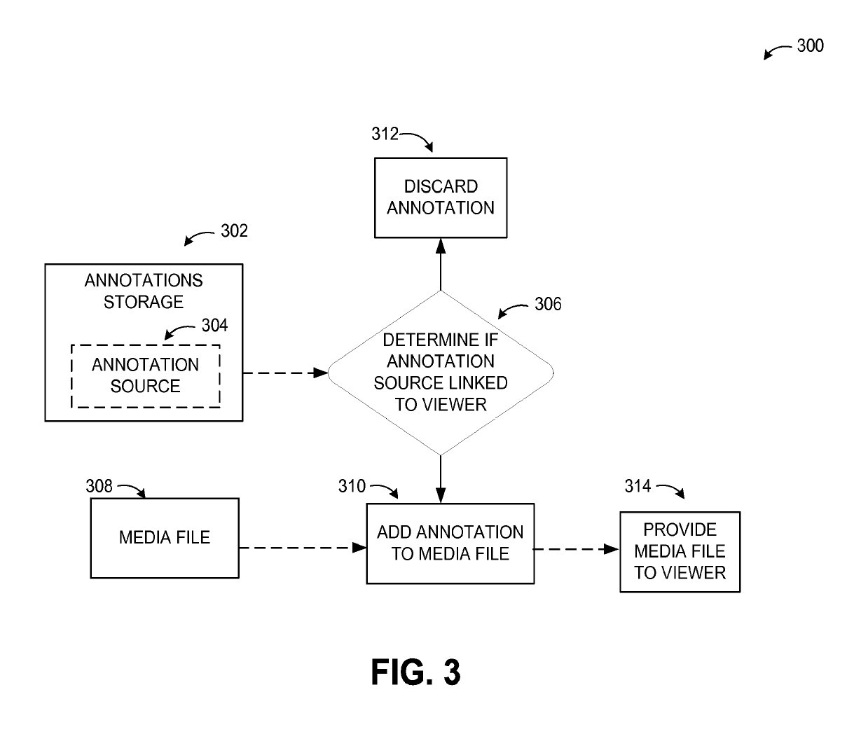

FIG. 3 illustrates actions in an example scenario for enabling a viewer to view annotations by users associated with the viewer, arranged in accordance with at least some embodiments described herein. As illustrated in a diagram 300, a media file 308 may be available for a user to annotate. The media file 308 may be hosted by a content provider, and may be provided to the user directly via the content provider. Additionally, the content provider may provide the media file 308 to one or more communication networks, and the user may access the media file 308 over the communication networks for annotating the media file. Likewise, a viewer may view the media file 308 with inserted annotations directly from the content provider, and additionally over the one or more communication networks.

In an example embodiment, when the user annotates, or inserts comments, onto the media file 308, the annotations associated with the media file 308 may be stored separately. The annotations may be stored in an annotation data store 302 at the content provider hosing the media file 308, and in another example scenario, the annotations may be stored in an annotation data store 302 at the communication network. The annotating user may access the content provider and annotate the media file 308 with the annotations from the annotation data store 302. In another example, the user may access the communication network for adding annotations to the medial file 308 via the communication network, such as a social network, and the annotations may be stored and overlaid on the media file 308 at the communication network. The annotations data store 302 may include source information 304 about the annotating user in order for determining if a viewer is allowed to view the annotations and the annotating user. The source information 304 may include information related to a persona and/or profile of the annotating user associated with one or more communication networks. For example, the source information 304 may include friends, acquaintances, family members, contacts, co-workers, and co-members of established groups affiliated with the annotating user on one or more communication networks, such as a social network, a professional network, and an enterprise network.

In an example scenario, when a viewer makes a request to view the media file 308 from the content provider and/or over a communication network, a determination 306 may be made as to whether the requesting viewer is associated with the annotating user based on the source information 304 included with the annotation associated with the requested media file 308. The determination 306 may be made by the content provider when the request is received, and additionally the determination 306 may be made by communication network receiving the media file 308 request. If the requesting viewer and the annotating user are determined to be associated, then the annotations may be overlaid 310 with the media file 308. The annotations may be overlaid with the media file 308 at the content provider, and in another embodiment the annotations may be overlaid with the media file 308 at the communication network receiving the request.

After overlaying the annotations with the media file 308, the annotated media file may be provided to the viewer. As previously described, the annotated media file may be provided to the viewer by the content provider directly, and additionally, the annotated media file may be provided to the viewer over the communication network utilized for requesting the media file 308. Additionally, the annotated media file may be provided to the requesting viewer in different formats based on the type of device utilized for requesting the media file. For example, the content provider may make the annotations available to the requesting viewer separately from the media file when the requesting user uses a smart phone, and the content provider may make the annotated media file with the overlaid annotations available to the requesting viewer when the requesting viewer uses a tablet or a personal computing device. If the requesting viewer and the annotating user are determined not to be associated or the viewer not permitted to view the annotations, then the annotations associated with the media file 308 may be discarded 312, so that they are not displayed on the media file 308 when the media file 308 is viewed by the requesting viewer.

Examples of annotated media may include training videos that allow members of each organization to annotate without worries of intellectual property dilution. For example, an employee at an inspection point may leave a comment “this is not how we actually do inspection at this plant, is the video in error or do we need to change procedure” and immediately spread highly useful information to appropriate colleagues.

In some examples, screen shots of annotations may be automatically or semi-automatically posted to a social feed, once such a system is running, so that friends know when someone has annotated a video (and how many annotations they have made). This may help with the viral spread of content and provide valuable prompts for social sharing of viewing experiences and increase use of social media, making it a desirable function for a social network.

In other examples, viewing may be largely simultaneous or may be widely different in time from the annotation act. For example, socially linked users may see their annotations in real time while watching something or it may be associated with an archival video or both. Furthermore, annotations may be maintained in separate files or formats from the annotated media. The annotations may also be routed to a different device like a smartphone, or even rendering into verbal comments by voice synthesis or recording the comments as verbal content.

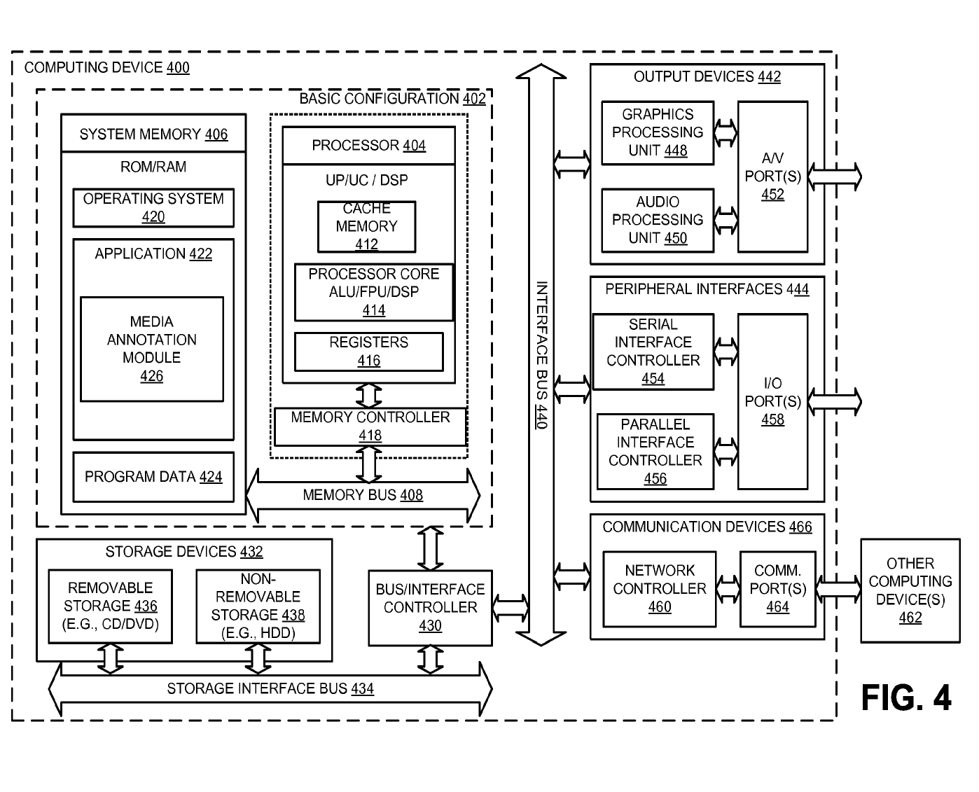

FIG. 4 illustrates a general purpose computing device, which may be used to control a system for displaying annotations on shared media from an annotation source associated with a viewer, arranged in accordance with at least some embodiments described herein. In a basic configuration 402, a computing device 400 typically includes one or more processors 404 and a system memory 406. A memory bus 408 may be used for communicating between a processor 404 and system a memory 406.

Depending on the desired configuration, the processor 404 may be of any type including but not limited to a microprocessor (μP), a microcontroller (μC), a digital signal processor (DSP), or any combination thereof. The processor 404 may include one more levels of caching, such as a level cache memory 412, a processor core 414, and one or more registers 416. The example processor core 414 may include an arithmetic logic unit (ALU), a floating point unit (FPU), a digital signal processing core (DSP Core), or any combination thereof. An example memory controller 418 may also be used with the processor 404, or in some implementations the memory controller 418 may be an internal part of the processor 404.

Depending on the desired configuration, the system memory 406 may be of any type including but not limited to volatile memory (such as RAM), non-volatile memory (such as ROM, flash memory, etc.) or any combination thereof. The system memory 406 may include an operating system 420, one or more applications 422, and program data 424. The application 422 may include a media annotation module 426 that is arranged to enable an annotating user to insert annotations at a selected timeframe on a media file and enable viewers associated with the annotating user to view the annotations. The program data 424 may include annotating user data, viewer data, and other similar data. The program data 424 may be useful in determining if the annotating user and the viewer are linked for determining which annotations to overlay with the media file when providing the media file to the viewer. This described basic configuration 402 is illustrated in FIG. 4 by those components within the inner dashed line.

The computing device 400 may have additional features or functionality, and additional interfaces to facilitate communications between the basic configuration 402 and any required devices and interfaces. For example, a bus/interface controller 430 may be used to facilitate communications between the basic configuration 402 and one or more data storage devices 432 via a storage interface bus 434. The data storage devices 432 may be removable storage devices 436, non-removable storage devices 438, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 406, the removable storage devices 436 and the non-removable storage devices 438 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by the computing device 400. Any such computer storage media may be part of the computing device 400.

The computing device 400 may also include an interface bus 440 for facilitating communication from various interface devices (e.g., output devices 442, peripheral interfaces 444, and communication devices 446) to the basic configuration 402 via the bus/interface controller 430. The example output devices 442 include a graphics processing unit 448 and an audio processing unit 450, which may be configured to communicate to various external devices such as a display or speakers via one or more AN ports 452. The example peripheral interfaces 444 include a serial interface controller 454 or a parallel interface controller 456, which may be configured to communicate with external devices such as input devices (e.g., keyboard, mouse, pen, voice input device, touch input device, etc.) or other peripheral devices (e.g., printer, scanner, etc.) via one or more I/O ports 458. An example communication device may include a network controller 460, which may be arranged to facilitate communications with one or more other computing devices 462 over a network communication link via one or more communication ports 464.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 400 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. The computing device 400 may also be implemented as a personal computer including both laptop computer and non-laptop computer configurations. Moreover the computing device 400 may be implemented as a networked system or as part of a general purpose or specialized server.

Example embodiments may also include methods. These methods can be implemented in any number of ways, including the structures described herein. One such way is by machine operations, of devices of the type described in the present disclosure. Another optional way is for one or more of the individual operations of the methods to be performed in conjunction with one or more human operators performing some of the operations while other operations are performed by machines. These human operators need not be collocated with each other, but each can be only with a machine that performs a portion of the program. In other examples, the human interaction can be automated such as by pre-selected criteria that are machine automated.

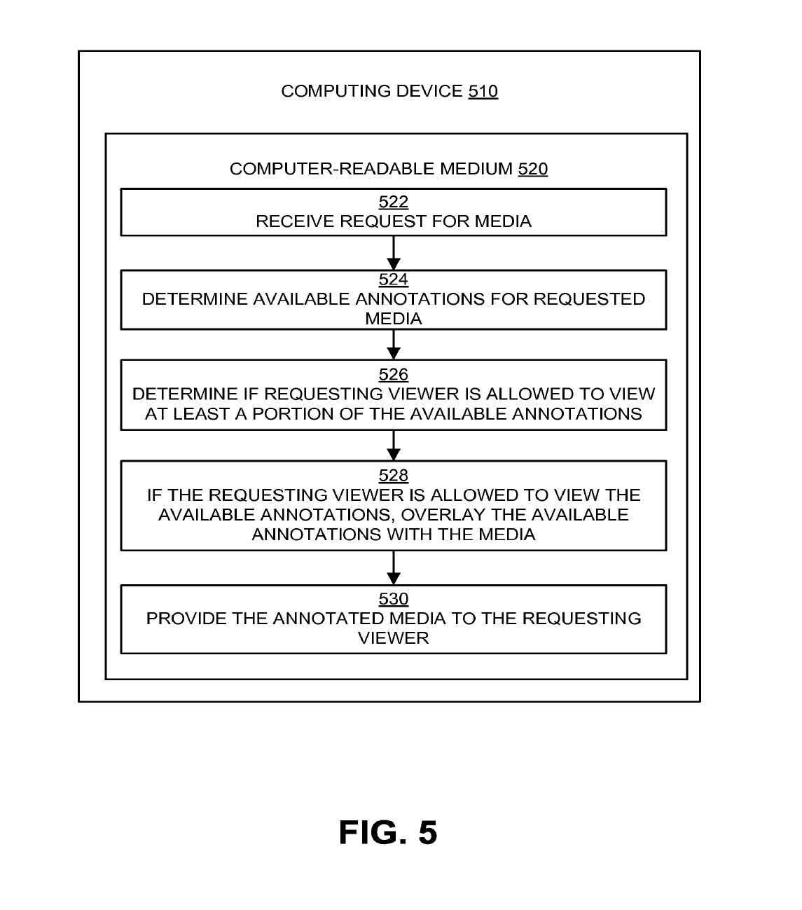

FIG. 5 is a flow diagram illustrating an example method that may be performed by a computing device such as the computing device in FIG. 4, arranged in accordance with at least some embodiments described herein.

Example methods may include one or more operations, functions or actions as illustrated by one or more of blocks 522, 524, 526, 528, and/or 530. The operations described in blocks 522 through 530 may also be stored as computer-executable instructions in a computer-readable medium such as a computer-readable medium 520 of a computing device 510.

A process for allowing merchants to provide packaging for ready recyclable items may begin with block 522, “RECEIVE REQUEST FOR MEDIA.” At block 522, a media content provider may receive a request to view media from a viewer. The media may be viewed at the media content provider, and additionally, the requesting viewer may view the media on a communication network, such as a social network, professional network, and/or enterprise network. The requested media may include a video file, a streaming video, a presentation, or an audio file.

Block 522 may be followed by block 524, “DETERMINE AVAILABLE ANNOTATIONS FOR REQUESTED MEDIA.” At block 524, the media content provider may determine if any annotations are available associated with the requested media. The available annotations may include textual comments, audio comments, and video comments which may be inserted at a selected timeframe of the media by an annotator.

Block 524 may be followed by block 526, “DETERMINE IF REQUESTING VIEWER ALLOWED TO VIEW THE AVAILABLE ANNOTATIONS.” At block 526, upon identifying annotations associated with the requested media, the media content provider may determine if the requesting viewer is allowed to view the available annotations associated with the requested media. The requesting viewer may be considered as allowed to view the available annotations if the requesting viewer is determined to have a relationship with the annotator, which may include a family relationship, a friendship, or a professional relationship. Additionally, the requesting viewer may be determined to be allowed to view the available annotations associated with the requested media if the requesting viewer specifies to view available annotations by one or more selected annotators.

Block 526 may be followed by block 528, “IF THE REQUESTING VIEWER IS ALLOWED TO VIEW THE AVAILABLE ANNOTATIONS, OVERLAY AT LEAST A PORTION OF THE AVAILABLE ANNOTATIONS WITH THE MEDIA.” At block 528, if the requesting viewer is determined to be allowed to view the available annotations, based on the relationship of the requesting viewer with the annotator and/or a specification to view available annotations by selected annotators, the annotations may be overlaid with the requested media. Some or all of the annotations may be overlaid at the content provider, and in another embodiment, the annotations may be overlaid at the communication network where the media may be viewed.

Block 528 may be followed by block 530, “PROVIDE THE ANNOTATED MEDIA TO THE REQUESTING VIEWER.” At block 530, the requested media including the overlaid annotations may be provided to the requesting viewer. The requesting viewer may view the media at the communication network and/or at the content provider. When the requesting viewer views the media, the overlaid annotations may be displayed at the corresponding timeframe where the annotations have been inserted by the annotators.

The blocks included in the above described process are for illustration purposes. Enabling viewers linked with an annotating user to view annotations inserted within viewed media files may be performed by similar processes with fewer or additional blocks. In some examples, the blocks may be performed in a different order. In some other examples, various blocks may be eliminated. In still other examples, various blocks may be divided into additional blocks, or combined together into fewer blocks. Although illustrated as sequentially ordered operations, in some implementations the various operations may be performed in a different order, or in some cases various operations may be performed at substantially the same time.

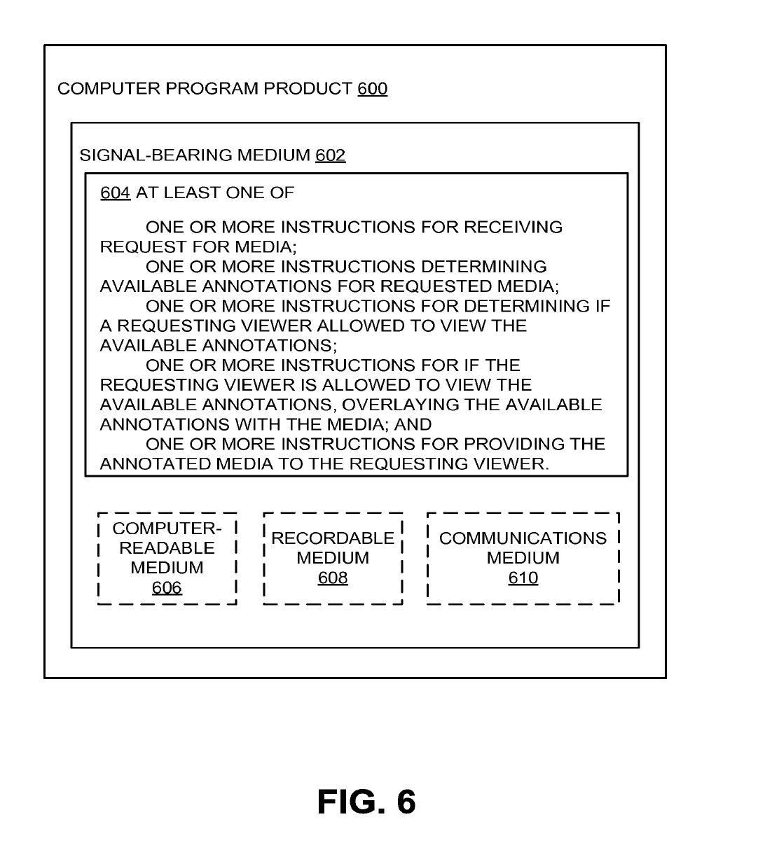

FIG. 6 illustrates a block diagram of an example computer program product, all arranged in accordance with at least some embodiments described herein. In some examples, as shown in FIG. 6, a computer program product 600 may include a signal bearing medium 602 that may also include machine readable instructions 604 that, when executed by, for example, a processor, may provide the functionality described above with respect to FIG. 4 and FIG. 5. Thus, for example, referring to the processor 404, the media annotation module 426 may undertake one or more of the tasks shown in FIG. 6 in response to the instructions 604 conveyed to the processor 404 by the signal bearing medium 602 to perform actions associated with enabling viewers linked with an annotating user to view annotations inserted within viewed media files as described herein. Some of those instructions may include receiving a request for media, determining available annotations for requested media, determining if a requesting viewer is allowed to view the available annotations, if the requesting viewer is allowed to view the available annotations, overlaying the available annotations with the media, and providing the annotated media to the requesting viewer.

In some implementations, the signal bearing medium 602 depicted in FIG. 6 may encompass a computer-readable medium 606, such as, but not limited to, a hard disk drive, a Compact Disc (CD), a Digital Versatile Disk (DVD), a digital tape, memory, etc. In some implementations, the signal bearing medium 602 may encompass a recordable medium 608, such as, but not limited to, memory, read/write (R/W) CDs, R/W DVDs, etc. In some implementations, the signal bearing medium 602 may encompass a communications medium 610, such as, but not limited to, a digital and/or an analog communication medium (e.g., a fiber optic cable, a waveguide, a wired communications link, a wireless communication link, etc.). Thus, for example, the program product 600 may be conveyed to one or more modules of the processor 404 by an RF signal bearing medium, where the signal bearing medium 602 is conveyed by a wireless communications medium 610 (e.g., a wireless communications medium conforming with the IEEE 802.11 standard).

According to some examples, the present disclosure describes a method for displaying annotations on shared media. The method may include receiving a request for media, determining an available annotation for the requested media, determining if a requesting viewer is allowed to view the available annotation, if the requesting viewer is allowed to view the available annotation, overlaying the available annotation with the media, and providing the annotated media to the requesting viewer.

According to some examples, determining if the requesting viewer is allowed to view the available annotation may include determining a relationship of the requesting viewer with an annotator. The relationship of the requesting viewer with the annotator may include one or more of: a family relationship, a friendship, and a professional relationship.

According to some examples, determining if the requesting viewer is allowed to view the available annotation may include receiving an indication from the requesting viewer specifying one or more annotators. The media may include one of a video file, a streaming video, a presentation, or an audio file. The available annotation may include one of a textual comment, an audio comment, and a video comment at a selected timeframe of the media.

According to other examples, the method may include storing the available annotation at a communication network, receiving the media from a content provider, and overlaying the available annotation with the media at the communication network. The communication network may be one of a social network, a professional network, and an enterprise network.

According to other examples, the method may include storing the available annotation and the media at a content provider, determining if the requesting viewer is allowed to view the available annotation based on information received from a communication network, and overlaying the available annotation with the media at the content provider.

According to other examples, the method may include storing the media at a content provider, storing the available annotation at a first communication network, determining if the requesting viewer is allowed to view the available annotation at a second communication network, receiving the media from the content provider and the available annotation from the first communication network, and overlaying the available annotation with the media at the second communication network.

According to other examples, the method may include enabling generation of the available annotation based on a role-based permission. The method may also include providing the annotated media to the requesting viewer based on a role-based permission. The method may further include enabling one of an annotator and an annotation source storing the available annotation to define permissions to view the annotated media.

According to other examples, the method may include automatically posting screenshots of the available annotation overlaid or adorned with the media on a communication network disseminating the annotated media. The screenshots may be arranged to indicate one or more of an availability, an update status, and a number of annotations overlaid with the media.

According to further examples, the method may include enabling viewing of the available annotation overlaid with the media and the media through two separate devices. The method may further include enabling the requesting viewer to select an annotation source for the available annotation to be overlaid with the media.

According to some examples, the present disclosure also describes a system for displaying annotations on shared media. The system may include a communication network configured to enable users exchange communications and share media and a media annotation module executed on a server. The media annotation module may be configured to receive a request for media, determine available annotation for the requested media, determine if a requesting viewer is allowed to view the available annotation, if the requesting viewer is allowed to view the available annotation, overlay the available annotation with the media, and provide the annotated media to the requesting viewer.

According to some examples, the media annotation module may be further configured to determine a relationship of the requesting viewer with an annotator. The relationship of the requesting viewer with the annotator may include one or more of: a family relationship, a friendship, and a professional relationship.

According to some examples, the media annotation module may be further configured to receive an indication from the requesting viewer specifying one or more annotators for providing the available annotation. The media annotation module may be further configured to receive the available annotation from an annotations store at the communication network, receive the media from a content provider, and overlay the available annotation with the media. The communication network may be one of a social network, a professional network, and an enterprise network.

According to some examples, the media annotation module may be further configured to receive the available annotation from an annotations store at another communication network, receive the media from a content provider, and overlay the available annotation with the media. The media may include one of a video file, a streaming video, a presentation, or an audio file. The available annotation may include one of a textual comment, an audio comment, and a video comment at a selected timeframe of the media.

According to other examples, the media annotation module may be further configured to enable generation of the available annotation based on a role-based permission. The media annotation module may be further configured to provide the annotated media to the requesting viewer based on a role-based permission.

According to other examples, the media annotation module may be further configured to enable one of an annotator and an annotation source storing the available annotation to define permissions to view the annotated media. The media annotation module may be further configured to automatically post screenshots of the available annotation overlaid with the media on a communication network disseminating the annotated media. The screenshots may be arranged to indicate one or more of an availability, an update status, and a number of annotations overlaid with the media.

According to further examples, the media annotation module may be further configured to enable viewing of the available annotation overlaid with the media and the media through two separate devices. The media annotation module may be further configured to enable the requesting viewer to select an annotation source for the available annotation to be overlaid with the media.

According to some examples, the present disclosure also describes a system for displaying annotations on shared media. The system may include a data store configured to store media for sharing and a content provider server. The content provider server may be configured to receive a request for media, determine available annotation for the requested media, determine if a requesting viewer is allowed to view the available annotation, if the requesting viewer is allowed to view the available annotation, overlay the available annotation with the media, and provide the annotated media to the requesting viewer.

According to some examples, the server may be further configured to determine a relationship of the requesting viewer with an annotator. The relationship of the requesting viewer with the annotator may include one or more of: a family relationship, a friendship, and a professional relationship. The media may include one of a video file, a streaming video, a presentation, or an audio file. The available annotation may include one of a textual comment, an audio comment, and a video comment at a selected timeframe of the media. The communication network may be one of a social network, a professional network, and an enterprise network.

According to other examples, the server may be further configured to enable generation of the available annotation based on a role-based permission. The server may be further configured to provide the annotated media to the requesting viewer based on a role-based permission.

According to other examples, the server may be further configured to enable one of an annotator and an annotation source storing the available annotation to define permissions to view the annotated media. The server may be further configured to automatically post screenshots of the available annotation overlaid with the media on a communication network disseminating the annotated media. The screenshots may be arranged to indicate one or more of an availability, an update status, and a number of annotations overlaid with the media.

According to further examples, the server may be further configured to enable viewing of the available annotation overlaid with the media and the media through two separate devices. The server may be further configured to enable the requesting viewer to select an annotation source for the available annotation to be overlaid with the media.

According to further examples, the present disclosure describes a computer readable memory device with instructions stored thereon for displaying annotations on shared media. The instructions may include receiving a request for media, determining an available annotation for the requested media, determining if a requesting viewer is allowed to view the available annotation, if the requesting viewer is allowed to view the available annotation, overlaying the available annotation with the media, and providing the annotated media to the requesting viewer.

According to some examples, determining if the requesting viewer is allowed to view the available annotation may include determining a relationship of the requesting viewer with an annotator. The relationship of the requesting viewer with the annotator may include one or more of: a family relationship, a friendship, and a professional relationship.

According to some examples, determining if the requesting viewer is allowed to view the available annotation may include receiving an indication from the requesting viewer specifying one or more annotators. The media may include one of a video file, a streaming video, a presentation, or an audio file. The available annotation may include one of a textual comment, an audio comment, and a video comment at a selected timeframe of the media.

According to other examples, the instructions may include storing the available annotation at a communication network, receiving the media from a content provider, and overlaying the available annotation with the media at the communication network. The communication network may be one of a social network, a professional network, and an enterprise network.

According to other examples, the instructions may include storing the available annotation and the media at a content provider, determining if the requesting viewer is allowed to view the available annotation based on information received from a communication network, and overlaying the available annotation with the media at the content provider.

According to other examples, the instructions may include storing the media at a content provider, storing the available annotation at a first communication network, determining if the requesting viewer is allowed to view the available annotation at a second communication network, receiving the media from the content provider and the available annotation from the first communication network, and overlaying the available annotation with the media at the second communication network.

According to other examples, the instructions may include enabling generation of the available annotation based on a role-based permission. The instructions may also include providing the annotated media to the requesting viewer based on a role-based permission. The instructions may further include enabling one of an annotator and an annotation source storing the available annotation to define permissions to view the annotated media.

According to other examples, the instructions may include automatically posting screenshots of the available annotation overlaid with the media on a communication network disseminating the annotated media. The screenshots may be arranged to indicate one or more of an availability, an update status, and a number of annotations overlaid with the media.

According to further examples, the instructions may include enabling viewing of the available annotation overlaid with the media and the media through two separate devices. The instructions may further include enabling the requesting viewer to select an annotation source for the available annotation to be overlaid with the media.

There is little distinction left between hardware and software implementations of aspects of systems; the use of hardware or software is generally (but not always, in that in certain contexts the choice between hardware and software may become significant) a design choice representing cost vs. efficiency tradeoffs. There are various vehicles by which processes and/or systems and/or other technologies described herein may be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g. as one or more programs running on one or more microprocessors), as firmware, or as virtually any combination thereof, and that designing the circuitry and/or writing the code for the software and or firmware would be well within the skill of one of skill in the art in light of this disclosure.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Versatile Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity of gantry systems; control motors for moving and/or adjusting components and/or quantities).

A typical data processing system may be implemented using any suitable commercially available components, such as those typically found in data computing/communication and/or network computing/communication systems. The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method for displaying annotations on shared media, the method comprising:
receiving a request for media;
determining an available annotation for the requested media;
enabling generation of the available annotation based on a role-based permission, wherein one of an annotator and an annotation source for the available annotation defines the role-based permission to view the annotated media;
determining if a requesting viewer is allowed to view the available annotation;
if the requesting viewer is allowed to view the available annotation, overlaying the available annotation with the media; and
providing the annotated media to the requesting viewer based on the role-based permission.

2. The method of claim 1, wherein determining if the requesting viewer is allowed to view the available annotation includes determining a relationship of the requesting viewer with an annotator.

3. The method of claim 2, wherein the relationship of the requesting viewer with the annotator includes one or more of: a family relationship, a friendship, and a professional relationship.

4. The method of claim 2, wherein determining if the requesting viewer is allowed to view the available annotation includes receiving an indication from the requesting viewer specifying one or more annotators.

5. (canceled)

6. (canceled)

7. The method of claim 1, further comprising:
storing the available annotation at a communication network;
receiving the media from a content provider; and
overlaying the available annotation with the media at the communication network.

8. (canceled)

9. The method of claim 1, further comprising:
storing the available annotation and the media at a content provider;
determining if the requesting viewer is allowed to view the available annotation based on information received from a communication network; and
overlaying the available annotation with the media at the content provider.

10. The method of claim 1, further comprising:
storing the media at a content provider;
storing the available annotation at a first communication network;
determining if the requesting viewer is allowed to view the available annotation at a second communication network;
receiving the media from the content provider and the available annotation from the first communication network; and
overlaying the available annotation with the media at the second communication network.

11. (canceled)

12. (canceled)

13. (canceled)

14. (canceled)

15. The method of claim 1, wherein screenshots of the available annotation overlaid with the media are automatically posted on a communication network and are arranged to indicate one or more of an availability, an update status, and a number of annotations overlaid with the media.

16. (canceled)

17. (canceled)

18. A system to display annotations on shared media, the system comprising:
a communication network configured to enable users exchange communications and share media;
a data store configured to store media for sharing; and
a media annotation module executed on a server, the media annotation module configured to:
receive a request for media;
determine available annotation for the requested media;
enable generation of the available annotation based on a role-based permission, wherein one of an annotator and an annotation source for the available annotation defines the role-based permission to view the annotated media;
determine if a requesting viewer is allowed to view the available annotation;
if the requesting viewer is allowed to view the available annotation, overlay the available annotation with the media;
provide the annotated media to the requesting viewer based on the role-based permission; and
enable viewing of the media and the available annotation overlaid with the media through two separate devices.

19. (canceled)

20. (canceled)

21. (canceled)

22. The system of claim 18, wherein the media annotation module is further configured to:
receive the available annotation from an annotations store at the communication network;
receive the media from a content provider; and
overlay the available annotation with the media.

23. The system of claim 22, wherein the communication network is one of a social network, a professional network, and an enterprise network.

24. The system of claim 18, wherein the media annotation module is further configured to:
receive the available annotation from an annotations store at another communication network;
receive the media from a content provider; and
overlay the available annotation with the media.

25. The system of claim 18, wherein the media includes one of a video file, a streaming video, a presentation, or an audio file.

26. The system of claim 18, wherein the available annotation includes one of a textual comment, an audio comment, and a video comment at a selected timeframe of the media.

27. (canceled)

28. (canceled)

29. (canceled)

30. The system of claim 18, wherein the media annotation module is further configured to:
automatically post screenshots of the available annotation overlaid with the media on a communication network disseminating the annotated media.

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. A computer readable memory device with instructions stored thereon to display annotations on shared media, the instructions comprising:
receiving a request for media at a content server;
determining available annotation for the requested media;
enabling generation of the available annotation based on a role-based permission, wherein one of an annotator and an annotation source for the available annotation defines the role-based permission to view the annotated media;
determining if a requesting viewer is allowed to view the available annotation;
enabling the requesting viewer to select an annotation source for the available annotation to be overlaid with the media;
if the requesting viewer is allowed to view the available annotation, overlaying the available annotation from the selected annotation source with the media; and
providing the annotated media to the requesting viewer based on the role-based permission.

48. (canceled)

49. The computer readable memory device of claim 47, wherein determining if the requesting viewer is allowed to view the available annotation includes determining a relationship of the requesting viewer with an annotator, wherein the relationship of the requesting viewer with the annotator includes one or more of: a family relationship, a friendship, and a professional relationship.

50. The computer readable memory device of claim 49, wherein determining if the requesting viewer is allowed to view the available annotation includes receiving an indication from the requesting viewer specifying one or more annotators.

51. (canceled)

52. (canceled)

53. The computer readable memory device of claim 47, wherein the instructions further comprise:
storing the available annotation at a communication network;
receiving the media from a content provider; and
overlaying the available annotation with the media at the communication network.

54. (canceled)

55. The computer readable memory device of claim 47, wherein the instructions further comprise:
storing the available annotation and the media at a content provider;
determining if the requesting viewer is allowed to view the available annotation based on information received from a communication network; and
overlaying the available annotation with the media at the content provider.

56. The computer readable memory device of claim 47, wherein the instructions further comprise:
storing the media at a content provider;
storing the available annotation at a first communication network;
determining if the requesting viewer is allowed to view the available annotation at a second communication network;
receiving the media from the content provider and the available annotation from the first communication network; and
overlaying the available annotation with the media at the second communication network.

57. (canceled)

58. (canceled)

59. (canceled)

60. The computer readable memory device of claim 47, wherein the instructions further comprise:
automatically posting screenshots of the available annotation overlaid with the media on a communication network disseminating the annotated media.

61. The computer readable memory device of claim 60, wherein the screenshots are arranged to indicate one or more of an availability, an update status, and a number of annotations overlaid with the media.

62. (canceled)

63. (canceled)
